(19) United States
(12) Patent Application Publication
(10) Pub. No.: US 2018/0082617 A1
(43) Pub. Date: Mar. 22, 2018

(54) Solar powered rotating graphic display for drinking cup

(71) Applicant: Abraham Contreras, Tucson, AZ (US)

(72) Inventor: Abraham Contreras, Tucson, AZ (US)

(21) Appl. No.: 15/330,395

(22) Filed: Sep. 16, 2016

(51) Int. Cl. G09F 23/00; A47G 19/22; B65D 43/02; F21L 4/08; H02S 40/38

(52) U.S. Cl. CPC G09F 23/00; A47G 19/2227; A47G 19/2272; G09F 2023/0025; F21L 4/08; H02S 40/38; B65D 43/0225

(57) ABSTRACT

A solar powered rotating graphic display for a drinking cup where the graphic display is located between an inner cup and an outer transparent cup. The display panel is attached to a base plate that is caused to rotate by a DC gear motor located at the bottom of the outer cup and just below the inner cup. A plurality of solar panels powers the DC gear motor causing the graphic panel to rotate.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of decorative drinking cups and more specifically to a solar powered rotating graphic display for a drinking cup. Drinking cup and other fluid carrying containers such as mugs or bottles are sometimes decorated with graphic images either for decorative purposes, or for advertising purposes. The graphic images, while colorful, tend to be non-moving. And therefore not as exciting as a moving display would be.
D. Rosenthal, in his U.S. Pat. No. 2,635,384 describes a drinking vessel with animated display where a graphic panel is caused to rotate between an inner cup and an outer cup. The display is driven by a wind up spring mechanism which is wound by the user by twisting a knob located at the bottom of the cup.
Although the animated display is more interesting and exciting than a static, nonmoving graphic display, it is deficient in that it is not dish washer safe in that water may enter the aperture where the shaft for the turning knob is located. It also takes effort to cause the display to rotate when the spring power has expired and needs to be recharged.
Even powering such a display by a motor and battery power is problematic in that the battery door needs to be completely water tight for the unit to be dish washer safe. Although this may be possible, it is costly, and requires the user to replace the battery from time to time, and to turn the unit on and off with an electric switch. If the switch is accidentally left on, the battery will drain prematurely.

### BRIEF SUMMARY OF THE INVENTION

The primary object of the invention is to provide a rotating graphic image within the inner and outer walls of drinking cup or other fluid carrying vessel that is caused to rotate by a DC gear motor that is powered by solar panels that are located at the bottom of the cup.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a solar powered rotating graphic display for a drinking cup comprising: an inner cup member, an outer cup member, a graphic panel member, a graphic panel member base plate, a DC powered gear motor, a motor housing, a plurality of solar panels, a battery, said inner cup member and said outer cup member being concentric with each other with a gap formed between the two, said outer cup member being transparent, said graphic panel member being approximately cylindrical in shape and concentrically located between the outer wall of said inner cup member and the inner wall of said outer cup member, said graphic panel attached at its lower perimeter to said graphic panel member base plate, said graphic panel base plate including a centrally located aperture that can receive the shaft portion of said DC powered gear motor, said DC powered gear motor located within said motor housing, said DC powered gear motor powered by said solar panels and/or said rechargeable battery which is charged by said solar panels, said plurality of solar panels vertically attached to the perimeter walls of said motor housing, and said graphic panel being caused to rotate when electrical power is sent to said DC powered gear motor by said solar panels or by said rechargeable battery.

### BRIEF DESCRIPTION OF THE DRAWINGS

FIG. 1 is a section view vertically bisecting of the invention.

FIG. 2 is a perspective view of the invention.

The drawings constitute a part of this specification and include exemplary embodiments to the invention, which may be embodied in various forms. It is to be understood that in some instances various aspects of the invention may be shown exaggerated or enlarged to facilitate an understanding of the invention.

### DETAILED DESCRIPTION OF THE INVENTION

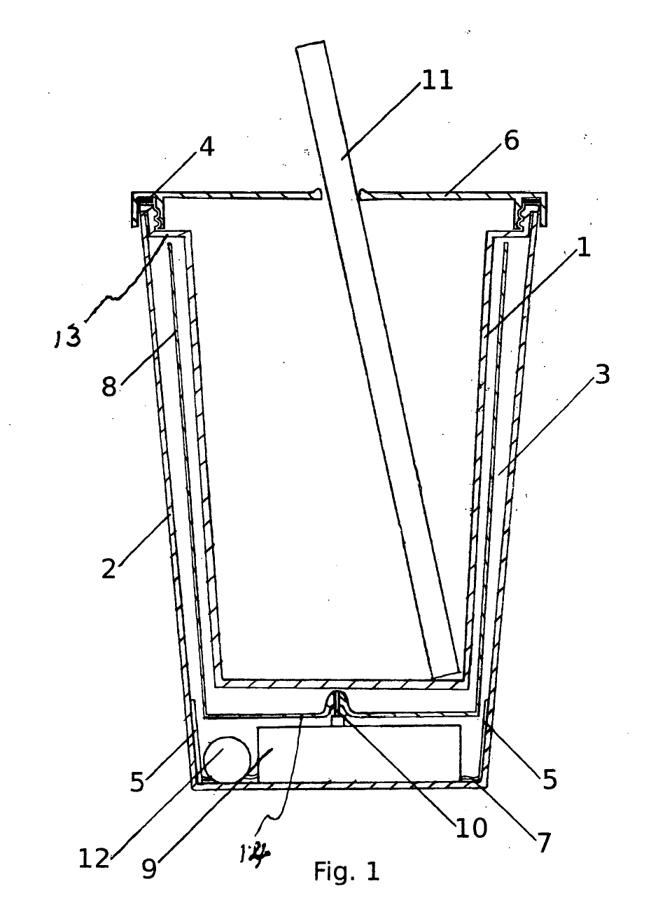

FIG. 1 is a section view that vertically bisects the invention. A graphic panel 8 is trapped in the space 3 between outer cup member 2 and an inner cup member 1. The graphic panel 8 is fixedly attached to a base plate 14. Outer cup member 2 is transparent thereby allowing a person to view the graphic panel 8 situated behind wall of the outer cup member 2. The base plate 14 includes an aperture that can fixedly retain shaft 10 of DC gear motor assembly 9 housed in an outer housing. An outwardly extending flange 13 extends outwardly from inner cup member 1 and is fixedly attached in a water-proof manner to the inner wall of outer cup member 2. A plurality of solar panels 5 powers the DC gear motor 9 and also charges the rechargeable battery 12 so that the battery 12 can operate the DC motor 9 during low light conditions. The shaft 10 of the DC gear motor rotates plate 14 and attached graphic panel 3. A lid 6 is threaded onto inner cup member 1. A hole in the center of the lid allows straw 11 to protrude.

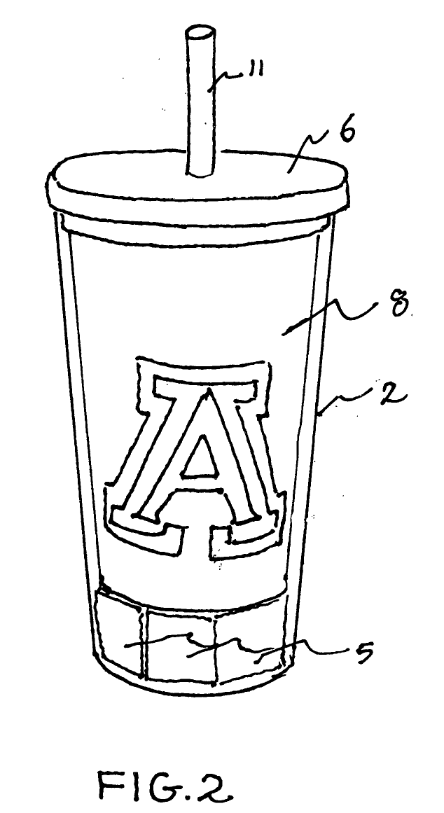

FIG. 2 is a perspective view of the invention. Graphic panel 8 rotates automatically when sunlight strikes solar panels 5. Graphic panel 8 can also rotate when powered by rechargeable battery 12. Lid 6 can be unthreaded as needed. Straw 11 protrudes from the center of the lid 6. The inner cup member 1 and outer cup member 2 are welded together in a water-proof manner so that the items stored between the two cups remain dry even when placed in a dish washer.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. solar powered rotating graphic display for drinking cup comprising:
an inner cup member;
an outer cup member;
a graphic panel member;
a graphic panel member base plate;
a DC powered gear motor;
a motor housing;
a plurality of solar panels;
a battery;
said inner cup member and said outer cup member being concentric with each other with a gap formed between the two;
said outer cup member being transparent;
said graphic panel member being approximately cylindrical in shape and concentrically located between the outer wall of said inner cup member and the inner wall of said outer cup member;
said graphic panel attached at its lower perimeter to said graphic panel member base plate;
said graphic panel base plate including a centrally located aperture that receives the shaft portion of said DC powered gear motor;
said DC powered gear motor located within said motor housing;
said DC powered gear motor powered by said solar panels and/or said rechargeable battery which is charged by said solar panels;
said plurality of solar panels vertically attached to the perimeter walls of said motor housing; and
said graphic panel being caused to rotate when electrical power is sent to said DC powered gear motor by said solar panels or by said rechargeable battery.

2. A solar power rotating graphic display for drinking cup as claimed in claim 1 wherein said inner cup member includes an outwardly disposed horizontal flange;
said flange fixedly attached to the inner wall of said outer cup member causing said gap between said inner cup member and said outer cup member.

3. A solar powered rotating graphic display for a drinking cup as claimed in claim 1 further comprising a threaded portion located on the uppermost inner wall of said outer cup member that can engage a matching threaded portion located on a lid designed to screw onto and off of said inner cup member.

4. A solar powered rotating graphic display for drinking cup as claimed in claim 1 wherein said the space within said inner cup member and said outer cup member is water resistant and said drinking cup is dish washer safe

5. A solar powered rotating graphic display for drinking cup as claimed in claim 1 wherein said solar powered rotating graphic panel can also be incorporated into a bottle, a mug, or other fluid filled containers.
